(19) United States
(12) Patent Application Publication
(10) Pub. No.: US 2004/0197592 A1
(43) Pub. Date: Oct. 7, 2004

(54) Gradient material molded body

(76) Inventors: Manfred Heinritz, Aalen (DE); Heinz-Michael Zaoralek, Konigsbronn (DE); Rainhard Laag, Bopfingen-Kerkingen (DE); Jurgen Kruger, Aalen (DE); Horst Herbst, Konigsbronn (DE)

Correspondence Address: RATNERPRESTIA, P O BOX 980, VALLEY FORGE, PA, 19482-0980, US

(21) Appl. No.: 10/827,146

(22) Filed: Apr. 19, 2004

Related U.S. Application Data
(63) Continuation of application No. 10/008,664, filed on Nov. 7, 2001, now abandoned.

(30) Foreign Application Priority Data
Nov. 9, 2000 (DE) 100 55 449.0

(51) Int. Cl. B32B 15/00

(52) U.S. Cl. 428/610

(57) ABSTRACT

A gradient material molded body, obtained in continuous casting from at least one metal alloy solidified in an outer shell of the molded body, outside the thermodynamic equilibrium.

A method for manufacturing a gradient material molded body, wherein the molded body is cast into its finished form in continuous casting from at least one metal molten mass which is alloyed supersaturated, and wherein an outer shell of the molded body is chilled into its crystal lattice in the course of said casting.

This application is a continuation of U.S. patent application Ser. No. 10/008,664, filed on Nov. 7, 2001, which is pending.

### BACKGROUND OF THE INVENTION

1. Technical Field

The invention relates to a gradient material molded body and to a method for manufacturing a gradient material molded body.

2. Description of the Related Art

It is advantageous in the manufacture of rollers for treating web-shaped materials, such as for example paper and sheet steel, if a roll barrel of a roller has a hard, wear-resistant surface and a comparatively softer core which is easy to machine. The roll barrel is manufactured, for example, from wrought steel whose surface is additionally subjected to a hardening process, for example inductive hardening.

For the manufacture of molded bodies, for example roll barrels such as the invention prefers but does not exclusively relate to, static casting, centrifugal casting and compound casting are introduced.

In static casting, molten iron or a molten iron base alloy is cast in a thick-walled mould made of metal. If a suitable alloy is used, rapid cooling in the peripheral area, i.e. in immediate proximity to the metal mould, can lead to white-solidifying of the iron, i.e. the carbon in the alloy remains between the iron crystal lattice sites. The lattice stressed in this way is very hard. Cooled more slowly, the carbon in the core of the roller emerges as graphite. A gray iron structure approaching conventional gray cast iron arises here. Such a bimetallic body having the desired characteristics arises in a casting.

Centrifugal casting differs from static casting essentially in the fact that the mould rotates. This offers the possibility of working with different casting alloys. Firstly, a sow-iron, possibly alloyed with chromium and nickel, is filled into the mould, where it is adapted by the centrifugal forces to the inside wall of the mould, and solidifies. Then the remaining mould space is filled up with the so-called core bar. By suitably adjusting the temperatures, the core bar and the sow-iron fuse, such that a bimetallic body likewise arises.

In compound casting too, two iron base alloys are used. The mould is static, as in casting. Once the entire mould has been filled with sow-iron, a solidified shell is allowed to form. The still molten core is then run off through an opening in the lower area of the mould. Once the run-off opening is closed, the mould is filled up again with the core bar. A variant also exists, whereby the still molten sow-iron is displaced by refilling with the core bar.

In casting, manufacturing the mould is expensive and costly. The mould consists of cast-iron rings, the casting dies, in premium quality. The casting dies have to be worked, coated on the inside and heated before each casting. Precisely aligning the over 100C hot casting dies is heavy work. Contact with the molten iron makes serious thermal demands on the inner side of the casting dies. Fractures arise, and the graphite burns. The casting dies therefore have to be changed after a few castings. A complete set of casting dies must be provided for each roller diameter to be supplied. Once the molten metal has been poured into the mould, no further possibility exists of influencing the casting quality.

In centrifugal casting, the rotating mould is, as a rule, formed by a pipe made of wrought, temperature-stable steel and is similarly expensive. At least one mould is required for each roller diameter to be supplied. Since the rollers have different lengths, a number of moulds with graduated lengths may in fact be economical. The roller is then cast in the smallest possible mould, and the part of the roller which is not required is separated off from the solidified casting body.

What has been said about casting also applies to compound casting. In addition, the expenditure in molten iron is almost twice as high. Furthermore, in the displacement method, the core bar constantly mixes with the displaced sow-iron, and this quantity of mixed iron is only reusable to a restricted extent.

U.S. Pat. No. 6,089,309 describes the manufacture of gradient materials in continuous die casting from two alloys cast together in a casting die. In the billet, a temperature field perpendicular to the direction of the billet is set such that significant atomic diffusion takes place in the liquid phase and in the high temperature range of the solid phase, in order to maintain a continuous change in the composition of the material perpendicular to the billet. The method is proposed, among other things, for the manufacture of steel and wrought products from iron base alloys.

### SUMMARY OF THE INVENTION

It is an object of the invention to provide roll barrels of rollers for treating web-shaped materials, and other molded bodies for which a gradient with respect to a mechanical and/or physical material characteristic is advantageous, and a method for efficiently manufacturing such molded bodies.

The object is solved by claims 1 and 14. Preferred embodiments and developments are described by the dependent claims.

The invention has recognized that continuous casting is suitable for efficiently manufacturing molded bodies with a gradient with respect to a mechanical and/or physical material characteristic. The molded body obtains its finished form in continuous casting without secondary reforming processes. The molded body in the sense of the invention is in particular not a semi-finished product which still has to be plastically formed, in order to manufacture a molded body. Material-removing processing after casting is not, however, to be ruled out. The gradient material molded body of the invention can even be cast with an overmeasure of material, and may be subjected immediately after casting to such material-removing processing as may still be required, for example polishing, turning on a lathe, fraising and/or drilling processes, in order to obtain a functional component for a machine. Finished components cast in the finished form can advantageously be obtained in the sense cited above from a single billet in identical or different lengths. By cutting it into lengths, the requirement—in particular the wishes of the customer—may flexibly be taken into account even during casting, by cutting the billet to the length required for the finished component. Subsequent cutting into lengths is not, however, to be ruled out.

Advantageously, material-removing surface finishing is only performed after casting to set a predetermined surface quality required for the finished component. The predetermined surface quality can in particular be surface roughness. A predetermined wettability of the surface of the finished component can likewise be worked on, to prepare the surface for example for a subsequent coating process using a coating material. Material-removing finishing, if such is required at all, preferably serves to maintain a predetermined surface roughness. Material-removing processing after casting may, however, also serve as appropriate to remove possible defects of form which may arise from casting, i.e. defects immanent to the method. Thus, the molded body directly obtained from casting may be slightly bent or bulged or may exhibit a number of indentations and/or constrictions, which can be removed by turning on a lathe, or if the defects of form are very small, by grinding. In this sense, a finished component close to the final contour is directly obtained from casting in accordance with the invention. Preferably, the casting molded body is close to the final contour in such a way that material-removing surface finishing is only to be performed on condition that a predetermined surface quality, for example surface roughness, is set. As a result, the molded body in accordance with the invention exhibits all material and geometrical characteristics, preferably within the tolerances which apply to the finished component. In accordance with the invention, continuous casting can thus be used for finished components which have hitherto been obtained from static casting, while continuous casting has hitherto only been used for manufacturing semi-finished products, and always with the tendency towards a largely homogenous structure.

In preferred embodiments, the invention aims to provide an at least equivalent and preferably superior alternative with respect to the gradient characteristic for molded bodies, which have hitherto only been cast statically. The roll barrels of rollers for processing web-shaped materials, for example for calenders for manufacturing paper, or also abrasion-proof casting bodies, in particular grinding bodies, chafing bodies and crushing bodies, for example for milling granulate materials, are particularly preferred example embodiments of such molded bodies. Such abrasion-proof casting bodies may also be used in the food industry, coating industry, cement and brick industry and coal grinding, to name but a few preferred applications. Such functional components are advantageously easy to machine. On the other hand, these functional components must have a wear-resistant surface, in order to be able to fulfil their actual function as an effecting body. The invention thus also has as its subject clear chill casting of cylindrical rotational bodies in the continuous casting method.

A gradient material molded body may be manufactured from a single original cast by alloying a metallic base molten mass in such a way that, with appropriate temperature treatment, it solidifies, when cast, outside the thermodynamic equilibrium, by forming one or more precipitation phases. Costly casting from a number of original casts of different compositions is not necessary, but is not to be ruled out. Thus, for example, casting-in a core from outside which is preferably already stabilized at its surface while forced cooling is simultaneously applied to the outside core can likewise be advantageous for solidifying the shell outside the thermodynamic equilibrium. The core and the shell can be cast jointly, wherein the likewise continuously cast core is, as already mentioned, stabilized at its surface once it has left its casting die until it enters the secondary casting die for casting-in.

The core may, however, also be formed by an imported core which has been previously formed elsewhere, for example cast independently. A preferred application for casting-in an imported core is the manufacture of a fiber-reinforced compound molded body. Such a compound molded body may be formed, for example, by a rolled aluminum-boron core which is cast-in in continuous casting, preferably with the gradient formed in casting.

A casting body in continuous casting is accessible to a far more intense temperature treatment, in particular significant supercooling, as compared to static casting. A cooling medium can act directly on the casting body moving in the billet. Cooling outside the casting die enables rapid cooling in the outer area of the billet. Intensive cooling while the casting body solidifies, preferably immediately behind the casting die, achieves a finely dispersed distribution of the precipitational phase or the several precipitational phases. As opposed to the conventional method of continuous casting, the thermal energy of the casting body is used in combination with the external forced cooling, to set the structure which is continuously changing from outside in. In traditional continuous casting, however, one tries to prevent variations in structure due to precipitations, or if this is not successful, to compensate for it through secondary heat treatment.

The casting body obtained in accordance with the invention does not require secondary heat treatment, although this can additionally be provided. The casting body's matrix can thus be conditioned by secondary heating and the diffusion processes which this enables in order to produce a structure in the casting body's shell which is closer to the thermodynamic equilibrium than immediately after casting. In casting from an iron base molten mass containing carbon, for example, this disperses the carbides more finely in the shell, to be preserved in this state by repeated rapid cooling. Due to the advantageous structure formation already provided by the invention, however, the energy required for secondary heating is kept low.

In preferred example embodiments, a core of the molded body solidifies in the thermodynamic equilibrium. The gradient is preferably set in a transition area between the core and the shell. A roll barrel for processing web-shaped materials or a grinding body for a grinding gear can in this case be maintained in the same or a similar structure as in known static casting methods for such bodies. However, significantly higher heat dissipation rates on the surface of the casting body can be set in continuous casting in accordance with the invention than in static casting, and therefore a particularly fine grain in the shell.

The at least one base molten mass can be an aluminum, titanium, nickel or copper base alloy. It is preferably an iron base alloy. Although in principle only one alloying element can be alloyed to the base element, the base molten mass is however preferably formed using at least two alloying elements, wherein each element in the molten mass alloyed to the base element exhibits a proportion which at most reaches as far as the nearest ternary eutectic. This also applies when more than two alloying elements are alloyed, wherein carbon is counted as an alloying element.

The at least one base molten mass is preferably a casting alloy, i.e. an alloy of metals in which the final form of the work piece, aside from relatively minor finishing as may be have to be performed, is obtained by pouring the alloy in a molten state into a suitable casting mold, as is the case in static mold casting. The casting alloy exhibits good casting characteristics. This requirement is best fulfilled by alloys which may be thermodynamically supercooled and thus metastably quenched, and which are therefore preferred casting alloys for gradient materials in accordance with the invention. Eutectically composed alloys, for example, are preferred alloys, in particular for molded bodies in which particularly fine granular structures are required, right into the core of the cast component. By contrast, continuous casting has hitherto been used for wrought alloys, and the semi-finished product forms such as rods, profiles and sheet metal are actually shaped by subsequent hot shaping and/or by mechanical processing, such that this can only be regarded as unfinished casting as opposed to mold casting. In an even more preferred embodiment, the casting alloy of the invention is modified as compared to a typical casting alloy in a way which favors the forming of precipitations. As a strong glass former, zirconium is a preferred alloying element for each of the base metals. For aluminum, silicon in particular is possible as an alloying element, preferably in combination with zirconium. It is particularly preferable for copper base alloys to contain one or more of the elements zirconium, boron and titanium as an alloying element. Where a hardness gradient is to be set, iron base alloys are alloyed in such a way that in continuous casting the shell is formed alloyed or unalloyed in chill casting, wherein the elements chromium and/or molybdenum are preferred alloying elements for chill casting alloyed.

A particularly preferred iron base molten mass is preferably sub-siliconized as compared to a typical casting iron and exhibits a silicon content of at least 0.1 and at most 1.2% by weight, preferably at most 0.8%. Otherwise, the alloy corresponds to casting iron alloys. The silicon content of the iron base molten mass is preferably higher, the higher the cooling rate of the casting body is. It also follows from this that the silicon content is advantageously chosen depending on the cross-section of the casting body obtained directly from continuous casting.

For a casting body with for example a circular cylindrical cross-section, the silicon content of the base molten mass is reduced with increasing diameter within said weight percentage area. This applies analogously to non circular cylindrical cross-sections.

An iron base molten mass is preferably supersaturated with carbon, the carbon content reaching from 0.2 to at most 5% by weight, preferably at most 4%. The molten mass can also advantageously be supersaturated with another alloying element in addition to supersaturating with carbon. Supersaturating with carbon and sub-siliconizing may be applied individually, but are particularly advantageous in combination for dispersing carbides in the shell while it is simultaneously solidifying stably in a core area of the casting body.

A similarly preferred iron base molten mass is formed by a tool steel alloy with a carbon content of at least 0.8 and at most 1.5% by weight, a chromium content of at least 5 and at most 12% by weight and at least one of the primary carbide formers vanadium, molybdenum and tungsten. If only one of the primary carbide formers is alloyed, then in the case of vanadium the vanadium content is at least 5 and at most 10% by weight, in the case of molybdenum the molybdenum content is at least 0.5 and at most 1.5% by weight, and in the case of tungsten the tungsten content is at most 1% by weight. If a combination of primary carbide formers is alloyed, the lower limits per alloying element may also be undershot. The contents of carbon and primary carbide formers are chosen within the given limits such that the carbon is used up in the formation of carbides by the primary carbide former or primary carbide formers. The alloying element chromium offsets the tolerance in the carbon, i.e. the imprecision in the addition of carbon which cannot ultimately be completely avoided, by forming chromium carbide. Zirconium and/or yttrium may also be components of the alloy as appropriate. The tool steel alloy preferably does not comprise silicon. The molded body exhibits the cited carbon content and, if present, also the contents of the other alloying elements in its cross-section because of the gradient in the mean.

Preferred gradient material molded bodies obtained in continuous casting from the tool steel alloy are roll barrels for rolling sheeting and/or roll barrels for sheeting calenders, in particular for high-strength, filled plastic films. A further example of a preferred gradient material molded body is worm fittings for extruders for manufacturing plastic profiles.

A further preferred application of the invention is the manufacture of rotating bodies, in particular roll barrels, with an elasticity modulus being well defined over the length of the roll barrel (Young's modulus), shortened to E-modulus in the following. In this way, a constant E-modulus of for example 210 GPa over the whole length of the roll barrel may be set for a roll barrel made of tool steel for a sheeting calender. Setting a defined E-modulus can likewise be applied to roll barrels made of casting iron and in principle all gradient material molded bodies in accordance with the invention. Continuous casting also enables controlled variation of the E-modulus over the length of the molded body. Through such targeted setting of the E-modulus, for example, the radial rigidity of a roll barrel for a calender in continuous casting, for example a paper calender, can be set axially in such a way that a gap formed between two involute roll barrels for web treating exhibits a constant gap width axially. The variation in the gap width to be expected when loaded without such compensating is thus already taken into account in casting by correspondingly varying the E-modulus axially.

When casting on the E-modulus, method parameters for continuous casting, such as for example the billet withdrawal speed and cooling of the billet surface, are chosen according to the E-modulus setting. A regulated casting method is preferably used for setting the E-modulus. The E-modulus is indirectly detected during casting, for example by means of ultrasound measuring and/or magnetostriction measuring at the billet during solidification. In the case of ultrasound measuring, the E-modulus is detected by determining its sound velocity. In this case the sound velocity forms the regulating variable for regulating the casting method.

The core area of the casting body can be fully cylindrical or hollow cylindrical. Continuously casting a hollow cylindrical casting body has the advantage that no internal shrinkage problem arises.

In preferred embodiments, a cylindrical casting body is obtained by casting a base alloy, for example an iron base alloy with a defined carbon content and a defined silicon content and possibly other alloying elements, to a continuous, preferably straight and vertical, billet in a device for continuous casting.

A mean billet withdrawal speed from the continuous casting die preferably fulfils the relation 10≦vₘ≦7×10⁷×D^{-z}. This results in a mean withdrawal speed vₘ in mm/min. D is the outer diameter of the body in mm, and z is a non-dimensional factor having a value in the range 1.9 to 2.0. For a full or hollow cylinder with an outer diameter of, for example, 1000 mm, the mean withdrawal speed fulfils the relation: 10 mm/min≦vₘ≦140 mm/min. The metallurgical length is preferably smaller than or at most equal to two thirds of the billet length.

The billet can be withdrawn from the continuous casting die at a uniform speed. In this case, an instantaneous withdrawal speed is constant and equal to the mean withdrawal speed. The instantaneous withdrawal speed can, however, oscillate, wherein the instantaneous withdrawal speed oscillates and/or changes periodically. Within this periodicity, the instantaneous withdrawal speed can even be zero, the resultant stationary phases not being longer than 5 seconds each.

Through the invention, a more extensive and more expensive plurality of casting dies may be dispensed with. Furthermore, only as much molten alloy has to be prepared as is necessary for the length of the molded body to be manufactured.

At a low mean withdrawal speed, supercooling the billet during withdrawal may be particularly closely adjusted to the desired gradient. Effectiveness and intensity are considerable extended as compared with static casting. By controlling the withdrawal speed and cooling of the billet, the solidification process in the billet is purposefully influenced with respect to the desired gradient. In this way, the thickness and uniformity in forming the shell are controllable. The fine granularity of the material structure is improved, and thus also the solidity and hardness of the surface.

Using effective quenchants on the surface of the billet, supercooling, nucleation and crystallization of the molten mass may be influenced in such a way that alloys arise well outside the thermodynamic equilibrium. In this way, mechanical and physical characteristics, such as for example hardness, tensile strength, heat conductivity, mechanical damping quality, and/or heat storage capacity, may be obtained which cannot be achieved in casting and centrifugal casting, or only with substantially higher technical expenditure. This is advantageous for the usage properties as well as the wear-resistance and corrosion-resistance.

The invention allows a multiphase gradient material to be purposefully manufactured from a single base alloy, the gradient material having a continuous but nonetheless defined transition between a hard shell and a comparatively softer core. In particular, the invention allows a bimetallic body to be purposefully manufactured from a base molten mass alloyed to metastably solidify.

In a preferred variant of the invention, two casting dies are arranged one behind the other on the path of the billet, in particular one below the other. The lower casting die in the billet has a greater diameter than the upper casting die. A core billet is formed in the upper casting die which leads through the lower casting die, and around which a shell alloy is cast in the lower casting die. In this way it is possible to manufacture a cylindrical bimetallic, body from gradient material in a continuous casting method, wherein the gradient material is formed by a first alloy for the core and by a second, different alloy for the shell.

### BRIEF DESCRIPTION OF THE DRAWING

A preferred example embodiment of the invention is explained in the following by way of the figure. The features disclosed therein develop the claimed invention, each individually and in combination.

FIG. 1 shows a schematic representation of a device for continuous casting, for manufacturing cylindrical molded body formed by clear chill casting.

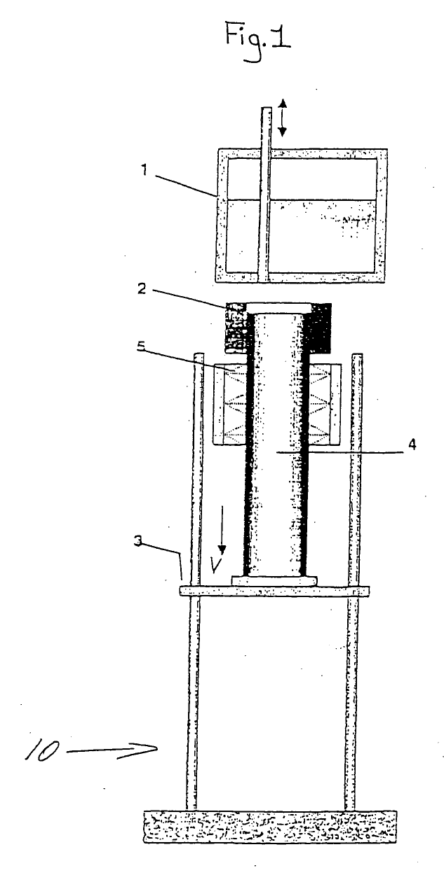

### DETAILED DESCRIPTION

A molten iron alloy with a carbon content in the range 2 to 5% by weight and a silicon content in the range 0.2 to 1.2% by weight, preferably 0.2 to 0.6%, relative to the overall mass of the alloy, is received into a heating means 1 in the device for continuous casting. A continuous casting die 2 is arranged beneath the heating means 1. A withdrawal device 10 with a withdrawing platform 3 is situated beneath the casting die 2. A cooling means 5, or possibly a number of cooling means, is/are arranged around the billet between the casting die 2 and the platform 3. The cooling means 5 comprise(s) blast nozzles for a gaseous coolant and/or spray nozzles for a liquid coolant.

The molten iron alloy is supplied from the heating means 1 of the casting die 2. In the cooled casting die 2, the molten mass solidifies at the surface in a thin crust. After the casting die 2, the thus stabilized billet 4 passes through the cooling means 5 and is control cooled, once it has been withdrawn from the sphere of influence of the casting die 2. Forced cooling begins near the casting die, preferably directly behind the casting die outlet.

As it passes through the cooling means 5, it is rapidly cooled, wherein carbides are precipitated in a finely dispersed distribution, and the fine granular structure is chilled in, within an outer shell of the billet and later molded body. Under the hard shell formed in this way, stable solidification takes place radially, i.e. the thermodynamically stable graphite phase is formed. In this way, a molded blank arises, with a gray cast iron core and a white-solidified shell, which is processed after casting in the same way as molded blanks obtained through static casting methods, in order to obtain, for example, a roll barrel for treating a web-shaped material, or a grinding body.

The billet 4 rests on the platform 3. By withdrawing the platform 3 within the withdrawal device 10, the billet 4 is withdrawn from the casting die 2. The withdrawal speed v of the billet 4, i.e. the speed with which the billet 4 is withdrawn from the casting die 2 and guided through the cooling means 5, is equal to the withdrawal speed of the platform 3.

The withdrawal device 10 supports and guides the platform 3. The platform 3 is preferably formed as a hydraulic lifting platform.

For casting an iron base alloy, the billet may have a diameter of up to 2000 mm in the case of a circular cylindrical billet. For continuous casting of a copper base alloy, the diameter of the billet can be a lot greater still, because of the higher heat conductivity of copper. In preferred example embodiments, the silicon content of an iron base molten mass is increased with the diameter of the billet. In the case of thin billets, for example around 200 mm, the silicon content can be up to 0.7%, while the silicon content of the base molten mass in thicker billets should be lower, and for a billet with a diameter of around 2000 mm preferably lowered to 0.1%. The formation of the gradient is assisted by sub-siliconizing.

The outer shell, solidified outside the thermodynamic equilibrium, is preferably thicker, the greater the diameter of the casting body, not least in order to obtain the desired greater overmeasure of material at greater diameters, in the case of metal-cut finishing the surface. In the case of diameters of 2000 mm, the chilled zone of the roll barrels preferably has a thickness of around 100 mm. For the majority of molded bodies, the chilled zone preferably has a thickness of 1 to 10% of the diameter of the casting body, wherein the thickness is set as uniformly as possible via the circumference of the casting body. For particular applications of the molded body, the thickness of the chilled zone can also be purposefully varied via the circumference.

For continuous casting of a hollow cylinder, a core or an inner casting die may be worked with. If a core is used for casting, then an embodiment of the platform, in such a way that the platform is connected to the underside of the core, is advantageous. The core itself is preferably fixed to a lifting and/or withdrawing device over the casting die.

In the foregoing description a preferred embodiment of the invention has been presented for the purpose of illustration and description. It is not intended to be exhaustive or to limit the invention to the precise form disclosed. Obvious modifications or variations are possible in light of the above teachings. The embodiment was chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A roll barrel for processing a web-shaped material, said roll barrel comprising:
a core; and
an outer shell,
said roll barrel being provided close to a final contour of a finished component, and not as a semi-finished component, through continuous casting from a metal alloy solidified in said outer shell of the roll barrel outside of thermodynamic equilibrium,
the metal alloy being solidified in the core stably, and the metal alloy being chilled in said outer shell in its crystal lattice by rapid cooling.

2. (Cancelled)

3. The roll barrel of claim 1 wherein the metal alloy is not a wrought alloy.

4. The roll barrel of claim 1 wherein the metal alloy is a casting iron alloy.

5. The roll barrel of claim 1 wherein the metal alloy is a tool steel alloy having a carbon content of at least 0.8 to at most 1.5% in the mean, and a chromium content of at least 5 and at most 12%, and contains at least one of the elements vanadium, molybdenum and tungsten as a further alloying element, wherein the vanadium content is at most 10%, the molybdenum content is at most 1.5% and the tungsten content is at most 1%, the contents each measured by weight.

6. (Cancelled)

7. (Cancelled)

8. The roll barrel of claim 1 wherein the outer shell exhibits a thickness between 1% and 20% of the mean distance between the surface of the shell and a central longitudinal axis of the roll barrel.

9. The roll barrel of claim 1 wherein a white-solidified iron base alloy forms the outer shell.

10. (Cancelled)

11. The roll barrel of claim 1, wherein the metal alloy is an iron base alloy.

12. The roll barrel of claim 1 wherein the roll barrel is a compound roll barrel having fibers extending in the casting direction of the roll barrel and cast-in by the metal alloy.

13. The gradient roll barrel of claim 1 wherein said roll barrel is an abrasion-proof casting body for at least one of milling, grinding, or chafing.

14. The roll barrel of claim 1 wherein the roll barrel is a cylindrical rotating body.
